(19) United States
(12) Patent Application Publication
(10) Pub. No.: US 2026/0091552 A1
(43) Pub. Date: Apr. 2, 2026

(54) END EFFECTOR APPARATUS AND METHOD FOR ADDITIVE MANUFACTURING WITH IN SITU MATERIAL DEPOSITION AND CURING

(71) Applicant: Joshua Adams, Webster Groves, MO (US)

(72) Inventor: Joshua Adams, Webster Groves, MO (US)

(21) Appl. No.: 18/904,073

(22) Filed: Oct. 1, 2024

(51) Int. Cl. B29C 64/209; B25J 11/00; B29C 64/112; B29C 64/118; B29C 64/264; B29C 64/371; B29C 64/393; B29K 63/00; B29K 75/00; B29K 83/00; B33Y 10/00; B33Y 30/00; B33Y 50/02

(52) U.S. Cl. CPC B29C 64/209; B25J 11/0075; B29C 64/112; B29C 64/118; B29C 64/264; B29C 64/371; B29C 64/393; B33Y 10/00; B33Y 30/00; B33Y 50/02; B29K 2063/00; B29K 2075/00; B29K 2083/00

(57) ABSTRACT

An end effector apparatus and method for additive manufacturing systems is disclosed, comprising a deposition nozzle configured to deposit UV-curable or thermosetting materials and an integrated curing unit for in situ curing of the deposited material. Attachable to multi-axis robotic devices, the apparatus enables complex movements and accurate material deposition without the constraints of an enclosed build volume. It operates effectively in non-specialized environments, eliminating the need for controlled environmental conditions. Features include a protective shielding mechanism to prevent unintended exposure of curing energy, filtration media to contain byproducts or unattached materials, and a vision system with sensors for real-time monitoring and adjustments. The invention facilitates efficient additive manufacturing by combining material deposition and curing into a single process, supporting multiple deposition methods and handling multiple materials to create composite structures. This adaptability allows for the production of high-quality parts with intricate geometries in various settings without compromising performance.

### FIELD

The present invention relates to the field of digital manufacturing systems and additive manufacturing technologies. More particularly, it pertains to an end effector apparatus designed for additive manufacturing systems capable of depositing curable materials and curing them in situ. The invention specifically addresses challenges in operating additive manufacturing equipment in non-specialized environments by providing an end effector that can be attached to multi-axis robotic devices, such as robotic arms or gantry systems, to perform precise material deposition and curing without the need for controlled environmental conditions.

### BACKGROUND

Additive manufacturing, commonly known as 3D printing, has revolutionized the production of complex parts by enabling objects to be built layer by layer from digital models. This technology allows for the creation of intricate geometries that are difficult or impossible to achieve with traditional subtractive manufacturing methods, such as machining or molding. The layer-by-layer approach also may serve to reduce material waste, making additive manufacturing an efficient alternative for producing custom or complex components.

End effectors are critical components of many additive manufacturing systems, serving as the interface between the robotic device and the material being deposited. They are responsible for precise material placement, controlling the flow and deposition of materials to build up the desired object. In traditional additive manufacturing setups, end effectors are designed for specific materials and processes, such as extruding thermoplastics in fused deposition modeling (FDM).

Currently, the majority of end effectors in additive manufacturing systems effectively handle single-material deposition. They are designed to work with specific materials, such as thermoplastic filaments or binders, providing precise control over material flow or jetting. This allows for consistent layer formation and reliable build quality in processes like FDM where material deposition occurs without the need for specialized in situ curing mechanisms at the point of deposition. In processes like FDM and selective laser sintering (SLS), the materials solidify upon cooling or sintering, enabling the construction of stable structures through controlled cooling or post-processing without curing.

Stereolithography (SLA) is one of the earliest and most widely used additive manufacturing technologies. It operates by using a laser or digital light projector to cure liquid photopolymer resin in planar “2.5D” layers, building a three-dimensional object from the bottom up. In an SLA system, a vat of UV-curable resin is exposed to a focused ultraviolet laser beam or other light source like an LCD screen. The UV light exposes a cross-sectional pattern of the part design on the liquid resin, solidifying the resin where it is exposed and leaving the rest of the resin liquid. After each layer is cured, the build platform moves, allowing the next layer to be formed on top of the previous one.

Limitations of SLA include:
Layer-by-Layer Constraint: SLA builds parts in a sequential, flat, layer-by-layer fashion within a controlled environment, which can limit the complexity of geometries, especially for overhangs and undercuts without support structures.
Controlled Environment Requirement: The process typically requires a specialized environment to maintain optimal temperature and prevent contamination, limiting its use in non-specialized settings.
Post-Processing Needs: Parts often require post-curing and support structure removal, adding time and steps to the manufacturing process.

MultiJet Printing (MJP) is an additive manufacturing process similar to standard inkjet printing but in three dimensions. MJP uses printhead technology to deposit tiny droplets of liquid photopolymer resin onto a build platform. Each layer is cured with UV light immediately after deposition. The process can also deposit support material simultaneously, which can be removed after printing. It allows for the use of multiple materials or colors within a single build, enabling the creation of complex parts with varying properties. Although MJP has much more flexibility of use when compared to SLA, it also has its limitations, including:
Layer-by-Layer Construction: Similar to SLA, MJP builds parts layer by layer, which can limit the ability to create complex geometries without support structures and can slow down the build process for large parts.
Environmental Controls: The technology requires a controlled build envelope with temperature and humidity conditions to ensure material properties and print quality.
Material Constraints: Limited to specific photopolymer resins, which may not offer the mechanical properties needed for functional parts.

Directed Energy Deposition (DED) is an additive manufacturing process used to build or repair components by melting material as it is deposited. In metal DED, this typically involves feeding metallic material in the form of powder or wire into a focused energy source, such as a laser, electron beam, or plasma arc, which melts the material and fuses it to the substrate or previous layers. The process is controlled by a multi-axis robotic system or gantry, allowing for complex geometries and the addition of material to existing parts. DED can process a wide range of metals, including titanium, stainless steel, nickel-based alloys, and more. The process allows for rapid material deposition, making it suitable for large parts or repair applications. Unlike SLA and MJF, DED is often used in conjunction with more flexible robotic platforms to build up material with more complexity than planar layers, however it too has significant limitations, including:
Surface Finish and Resolution: DED typically produces parts with rough surface finishes and lower dimensional accuracy compared to powder bed fusion processes, requiring post-processing for critical applications.
Heat Input and Thermal Effects: The high heat input can lead to thermal stresses, distortion, and alterations in material properties, necessitating careful process control.
Protective Environment Requirements: DED processes often require inert gas shielding to prevent oxidation, especially with reactive metals, which adds complexity and cost.
Near-Net Shape: Due to the distortion caused by high heat in the process, parts produced with DED are often Near-Net-Shape, meaning that they require post processing (such as machining, surface finishing or other alterations) in order to to meet the specifications required by their ultimate use.

The discussed technologies have enabled significant advancements in additive manufacturing, allowing for the production of complex parts with structural integrity and precision useful for a growing range of applications, from prototyping to small-scale production. However, there is a clear need for an additive manufacturing end effector capable of:
Depositing curable materials and curing them immediately at the point of deposition without relying on controlled environments.
Functioning effectively in variable environmental conditions, such as fluctuating temperatures or humidity levels, without compromising material properties or part quality.
Enabling the creation of intricate, non-planar geometries without the need for extensive support structures or post-processing.
Handling multiple materials, including UV-curable resins and thermosets, and supporting both bead and spray deposition methods for greater adaptability.

### SUMMARY

The present invention pertains to an end effector apparatus for additive manufacturing systems, specifically designed to deposit curable materials and cure them in situ while operating in non-specialized environments. The apparatus comprises a deposition nozzle configured to deposit UV-curable or thermosetting materials and an integrated curing unit, such as a UV light source or catalyst introducer, positioned within or adjacent to the nozzle for rapid curing of the deposited material. This integration reduces processing times and enhances the structural integrity of fabricated parts.

The end effector is attachable to multi-axis robotic devices, including robotic arms and gantry systems, enabling complex movements and accurate material placement in both planar and non-planar machine paths. A significant innovative aspect is its ability to function without controlled environmental conditions, overcoming limitations of existing technologies that require specialized environments. The apparatus may include additional features such as a protective shielding mechanism to prevent unintended exposure to curing energy, filtration media to contain byproducts or unattached materials, and various sensing technologies.

Some embodiments of the invention may incorporate a vision system that employs sensors like visible light cameras, infrared or ultraviolet sensors, and three-dimensional scanning devices to monitor the manufacturing process in real time. Image processing algorithms detect deviations from the intended build path or geometry, allowing the system to adjust robotic movements, material flow rates, and curing parameters dynamically. This closed-loop control enhances precision, compensates for environmental variations, and reduces the likelihood of defects.

The invention enables efficient additive manufacturing by combining material deposition and curing into a single, streamlined process operable in diverse environments, including factory floors, outdoor sites, and for on-site repairs. Different embodiments of the invention may support multiple deposition methods, such as bead and spray deposition, and may handle multiple materials simultaneously or sequentially to create composite structures. The apparatus's adaptability eliminates the need for controlled environments, reducing infrastructure costs and increasing deployment flexibility across various industries.

### DEFINITIONS

Unless otherwise specified, the following terms as used herein have the meanings provided below:

The term “additive manufacturing”, “3D printing”, and abbreviated as “AM” refers to processes in which three-dimensional objects are built by adding material to a platform or substrate based on a digital model. In this context, additive manufacturing encompasses the use of robotic devices to deposit materials in a controlled manner to create complex structures, potentially with varying materials and embedded components.

The term “digital manufacturing” involves the use of digital technologies to design and produce products including additive manufacturing and other forms of manufacturing such as subtractive manufacturing like CNC machining. It integrates computer-aided design (CAD), computer-aided manufacturing (CAM), and other digital tools to streamline production processes. In this invention, digital manufacturing refers to the entire workflow from digital design to physical fabrication using robotic devices, end effectors, and vision systems that are controlled and adjusted based on digital data inputs.

The term “robotic device” in this invention refers to any mechatronic system capable of sensing and/or actuation, including but not limited to robotic arms and gantry systems. These devices are equipped with multiple degrees of freedom and are capable of precise movements and manipulations. They form the core of this digital manufacturing system, handling tasks such as material deposition, curing, and embedding components.

The term “planar digital manufacturing” refers to processes involving layer by layer, flat, horizontal planes. The term “non-planar digital manufacturing” extends beyond this by allowing material deposition or subtraction along curved or complex paths, enabling the creation of objects with intricate geometries without being restricted to flat planes. The term “not 2.5D” emphasizes that this system is capable of true three-dimensional fabrication, utilizing the full range of motion provided by multi-axis robotic devices to fabricate parts with complex, non-planar deposition paths.

The term “end effector” in this invention refers to the tool attached to the robotic device that interacts with the environment to perform specific tasks. The end effector extends to include any associated components required for material handling, comprising elements such as pumping systems, mixers, temperature control units, electronics, vision and computational systems as well as associated components such as mechanisms for tertiary material introduction, or alteration anywhere within the system, not necessarily at the actuated end of a robotic device that is interacting with the work piece. If present in a given embodiment, the end effector would encompass both the deposition nozzle for material placement, any curing units, vision and computation systems and the material handling system from material reservoir through delivery to the nozzle.

The term “vision system” in this invention includes all sensing devices that collect data to monitor and adjust the manufacturing process, or perform final inspection. This encompasses not only visible light cameras but also sensors operating in non-visible electromagnetic (EM) frequencies, such as infrared or ultraviolet. It may also include thermal sensors, force sensors, magnetic or electric field sensors. The vision system incorporates technologies like 3D scanning, and other modeling and processing methods to create accurate representations of the build process for real-time adjustments.

The term “3D scanning” refers to the process of analyzing a real-world environment or object to collect data on its shape and possibly its appearance (e.g., color, texture). In the context of this invention, it broadly includes any method of capturing three-dimensional data, such as laser scanning, photogrammetry, and other techniques. This data is used to create digital models or to monitor the additive manufacturing process for deviations from the intended design.

The term “Degrees of Freedom” and “DoF” refer to the number of independent movements a robotic device can perform. In this invention, robotic devices with multiple DoF allow for complex motions in three-dimensional space, including translation along and rotation about the X, Y, and Z axes. This capability enables precise positioning and orientation of the end effectors for material deposition, curing, and embedding in both planar and non-planar additive manufacturing.

The term “specialized environment” refers to controlled settings that maintain specific conditions such as temperature, humidity, cleanliness, and air quality, often required for traditional additive manufacturing processes to ensure material properties and part quality. In this invention, operating “without the need for a specialized environment” means that the system can function effectively in standard or variable conditions, such as factory floors, outdoor environments, or other locations, without additional environmental controls or enclosures.

The term “material” refers to any substance deposited by the digital manufacturing system to build the three-dimensional object. This includes UV-curable resins, thermosets, thermoplastics, and any additional curable, meltable or functionally inert materials introduced during the process. Materials can be used individually or combined to create composites with desired mechanical, electrical, or thermal properties.

The term “primary curable material” is the substance deposited by the system comprising proportionally more volume than any other curable material in a given volume. The primary curable material undergoes a curing process, initiated by mechanisms such as UV exposure, heat, or chemical catalyst, transforming it from a liquid or pliable state to a solid state.

The term “cure” comprises any process that hardens or solidifies the deposited material, transforming it from a liquid or malleable state to a more rigid, stable form. This can involve chemical reactions initiated by UV light (photopolymerization), heat (thermosetting), or the introduction of a physical catalyst as in room temperature vulcanizing multi-part urethanes, epoxies, and silicones. Curing goes beyond merely cooling a melted material (as in thermoplastics) and involves changing the chemical structure of the material to achieve desired mechanical properties.

The term “physical catalyst” is a substance or agent introduced to the curable material to initiate or accelerate the curing process. In this invention, the end effector may introduce a physical catalyst via a mixing mechanism, if required, into the material stream to enable curing in situ, particularly for materials that require a catalyst to harden.

The term “UV-curable resin” refers to a type of photopolymer that hardens when exposed to ultraviolet light due to photoinitiated polymerization reactions.

The term “thermoset” refers to a polymer material that irreversibly cures through heat or chemical additives, forming cross-linked structures that do not melt upon reheating.

The term “shielding” in this invention is a component of the end effector designed to prevent unintended exposure of curing energy or material (e.g., UV light, heat, articulates) to areas outside the targeted deposition zone, or prevent unintended exposure of energy, gas, or material to the workpiece. It may include physical barriers, reflective coatings, atmospheric management or enclosures that block or contain radiation, vapors, or materials, ensuring safety and preventing interference with surrounding processes or components.

The term “filtration media” refers to materials or systems integrated into an end effector that capture and prevent the spread of unattached materials, byproducts, or particulates generated during the additive manufacturing process. This can include passive absorptive materials or active systems such as those that use vacuum suction through filters to remove contaminants from the environment, maintaining cleanliness and safety.

The term “in situ” refers to a process occurring directly at the location where the material is deposited during additive manufacturing. In the context of this invention, “in situ” signifies that the curing of the deposited material happens immediately and precisely at the point of deposition, without requiring the material or workpiece to be moved to a separate location or subjected to additional handling steps for curing. This direct curing at the deposition site is integral to the continuous additive manufacturing process described in this patent, allowing for seamless integration of material placement and solidification within a single, streamlined operation.

The term “workpiece” refers to the object or substrate that is being acted upon by the additive manufacturing system during the fabrication process. In the context of this invention, the workpiece includes any intermediate or final product formed by the deposition of materials using the end effector apparatus. It encompasses the initial substrate onto which materials are deposited, as well as the progressively built structure resulting from successive layers or additions of material. The workpiece may consist of various materials and can be of any shape or size, serving as the foundation or framework for the additive manufacturing operations performed by the robotic device and end effector.

### BRIEF DESCRIPTION OF THE DRAWINGS

FIG. 1 Side view of the end effector attached to a multi-axis robotic arm.

FIG. 2 Perspective view of a first embodiment of the end effector.

FIG. 3 Side view of a first embodiment of the end effector.

FIG. 4 CROSS SECTIONAL VIEW OF A FIRST EMBODIMENT OF THE END EFFECTOR.

FIG. 5 Cross sectional view of a second embodiment of the end effector, with a spray nozzle.

FIG. 6 Cross sectional view of a third embodiment of the end effector, a nozzle that introduces a secondary material into a spray or bead based deposition flow.

FIG. 7 Cross sectional view of a fourth embodiment of the end effector, with a nozzle utilizing baffles to mix materials before deposition.

FIG. 8 Image of the front view of the first embodiment of the end effector with a solid mid-body.

FIG. 9 Image of the front view of the first embodiment of the end effector with a fine porosity mid-body.

FIG. 10 Image of the front view of the first embodiment of the end effector with a coarse porosity mid-body.

FIG. 11 Perspective image of the first embodiment of the end effector with a coarse porosity mid-body.

FIG. 12 Drawing of a peristaltic pump driven material supply system in which the material of the two pumps are forced through a static mix tube.

FIG. 13 Perspective view of a fifth embodiment of the end effector.

FIG. 14 Side view of the fifth embodiment of the end effector with internal geometries represented by dotted lines.

FIG. 15 Front view of the fifth embodiment of the end effector.

FIG. 16 Cross sectional side view of the fifth embodiment of the end effector.

FIG. 17 Image of the front view of the fifth embodiment of the end effector.

FIG. 18 Image of the perspective view of the front facing first embodiment with fine porosity mid-body and the fifth embodiment of the end effector side by side.

FIG. 19 Image of the perspective view of the rear facing first embodiment with fine porosity mid-body and the fifth embodiment of the end effector side by side.

FIG. 20 Perspective view of a sixth embodiment of the end effector.

FIG. 21 Side view of the sixth embodiment of the end effector.

FIG. 22 Perspective view of a magnetic or electrostatic docking mechanism.

FIG. 23 Direct view of the mating surfaces of a magnetic or electrostatic docking mechanism.

FIG. 24 Flow diagram describing the automated, self revising machine pathing, additive manufacturing, verification measurement system according to an embodiment of the invention.

### DETAILED DESCRIPTION

The present invention pertains to an end effector apparatus designed for use in additive manufacturing systems. This apparatus enables the deposition of curable materials and their in situ curing, thereby facilitating efficient fabrication of three-dimensional objects without the need for specialized environments. The end effector is specifically configured to integrate with multi-axis robotic devices, such as robotic arms or gantry systems, allowing for complex movements and accurate material placement in both planar and non-planar additive manufacturing machine paths.

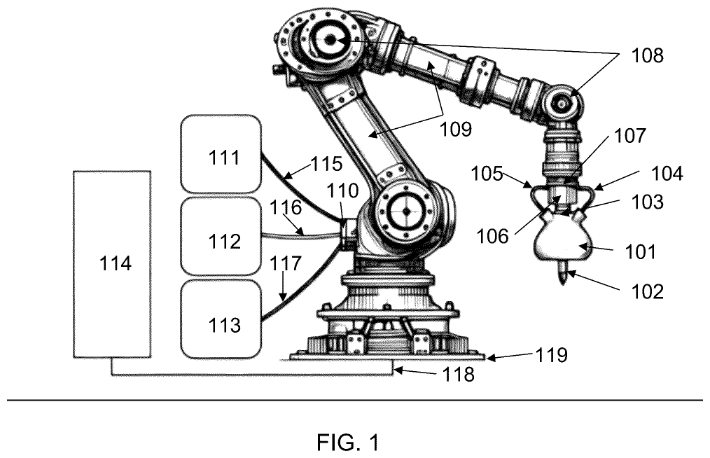

An embodiment of the end effector apparatus integrated with a robotic arm is illustrated in FIG. 1. The distal portion of the end effector 101 is fixtured onto the robotic arm at junction 107 which is also the connection point for the robotic junction component 106 to connect the internal material line, load bearing attachment point 103, and any distal transfer lines 104 & 105 to robot linkage transfer lines. The deposition nozzle 102 is connected to the material line as the last element of the apparatus that makes physical contact with the deposited material before it is applied to the workpiece as a bead or spray. In this embodiment all robotic linkage material and gas transfer lines are contained within the robotic arm, passing through all joints 108 and structural linkages 109 until their ultimate exit from the robotic arm at junction 110. Note: Alternative embodiments of the end effector may route some or all of the robotic linkage based material or gas lines external to the structure of the robotic device. A material reservoir system 111 is connected to the robotic linkage material line that runs through the robotic device via the proximal material transfer line 115. The material reservoir system may contain one or more heating, cooling, agitation, and pumping mechanisms as is required by a given material or materials that it contains. If present in a given embodiment a vacuum unit 112 will connect to the robotic linkage vacuum transfer lines through the proximal vacuum transfer line 116. If present in a given embodiment, the supply unit 113 will provide the gas or fluid to the robotic linkage gas or liquid transfer line through the proximal gas or liquid transfer line 117. Also shown in the embodiment depicted in FIG. 1. is a computation system 114 which connects to the end effector and in some embodiments the robotic arm via 118. Depending on the embodiment, this connection at 118 may be used for data transfer, power supply, or light energy which may be transmitted via fiber optic. Finally the environmental contact point 119 may be placed or fixed between the robotic device and the ground, table, wall or other environmental element against which it contacts. Alternatively the environmental contact point may be via a mobile platform such as one with the capacity to self relocate between workpieces, or as a means for additional degrees of freedom within one given digital manufacturing process.

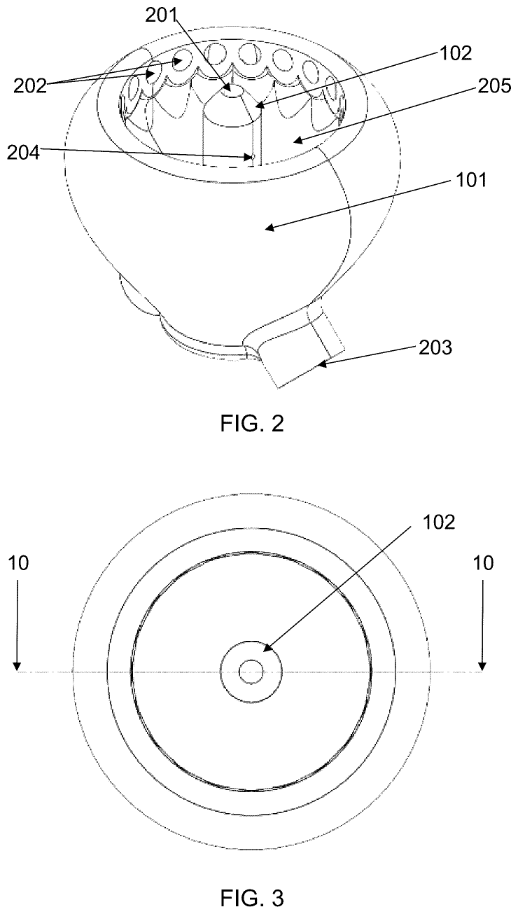

In FIG. 2. a perspective view of the distal portion of the end effector 101 is shown with several of the core elements present in most embodiments of the invention. The deposition nozzle 102 contains a material channel 201 through which material is deposited via bead based extrusion or spraying onto the workpiece. In this embodiment vacuum or forced air may be pulled/supplied from/to the immediate environment of deposition via channel openings 202 that internally connect to transfer ports 203. In situ curing and sensory systems may interface through ports 204 that may be present on the nozzle, as in this embodiment, or at other locations of the distal portion of the end effector enabling the material to be cured immediately upon, or soon after deposition, and for local measurements to be taken for process monitoring and validation. In this embodiment the surface of the midbody 205 of the distal end effector is solid, non-permeable material.

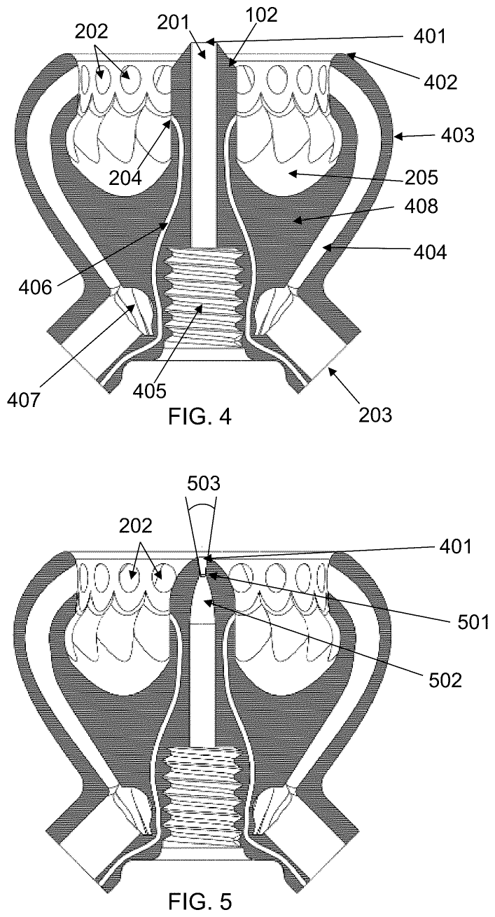

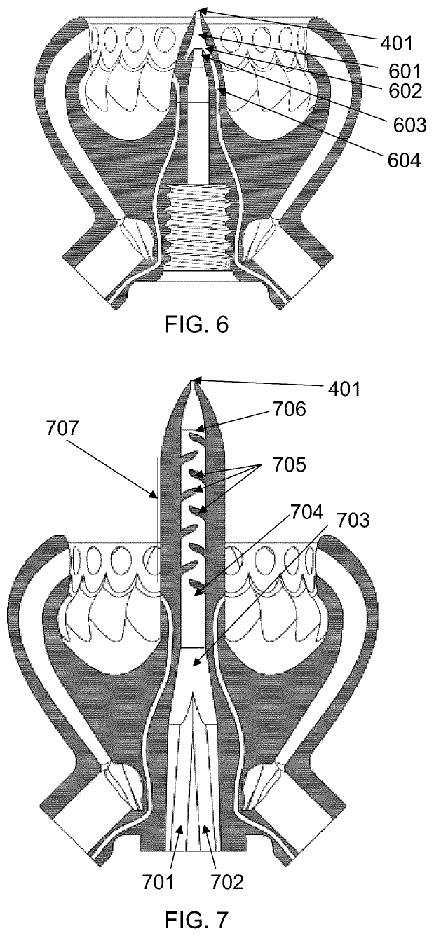

FIG. 3 shows front view of the distal portion of the end effector in order to give reference for the cross sections plane 10 used in FIG. 4, FIG. 5, FIG. 6 and FIG. 7. The deposition nozzle 102 is pointed out to give a more clear orientation to the view point.

FIG. 4 depicts a cross sectional view of plane 10 in order to illustrate the elements that embodiments of the distal portion of the end effector may contain. FIG. 4 shows some common elements for orientation such as the deposition nozzle 102, material channel through the deposition nozzle 201, vacuum/forced air ports 202, and transfer ports 203. This drawing further depicts important features such as the most distal point of the deposition nozzle 401, which must be at least 0.75 mm further forward than the most distal lip of the end effector 402 when beads are to be deposited. In cases where the nozzle applies material via spray, this can be possible for the body or protective shielding of the lip of the most distal portion of the end effector to be further forward than the most distal portion of the deposition nozzle. In this embodiment the maximal width of the distal portion of the end effector 403 is the largest diameter of the end effector. The vacuum/forced air ports 202 feed into internal vacuum/forced air channels 404. In this embodiment the internal vacuum/forced air channels all combine into a taurus like channel 407 before connecting to transfer ports 203. In this embodiment, the load bearing structure that connects the distal portion of the end effector is a threaded section 405, designed to connect to the material feed line via hollow threaded rod. In this embodiment the curing and sensory systems may exit through ports depicted at point 204, which are the terminal points of curing and sensory channels 406 designed to deliver wiring, fiber optic filament or other connection to the rest of the end effector to support their operation and utilize generated data. The surface of the midbody 205 of the distal portion of the end effector is pointed out, as well as the volumetric portion of the mid body 408. The volumetric portion of the mid body may include any volume between and inclusive of the internal vacuum/forced air channels 404, the curing and sensory channels 406, and outside of the material deposition channel 201.

FIG. 5 Depicts an embodiment of the end effector specialized to the purpose of spraying curable material onto the workpiece. In this case, the most distal point of the deposition nozzle 401 does not extend past the most distal lip of the end effector. Especially for spray applications this relationship between the deposition nozzle and the shielding terminating in the distal lip of the end effector can reduce turbulent air or wind interference from the external environment. Furthermore, forced air from a plurality of ports 202 can be used to advantageously affect the atomization and deposition landing location on the workpiece. In this embodiment of a spray nozzle, there is a necking down of the material deposition channel 502, to a most narrow point 501 for the purpose of accelerating the curable material and any other materials it may contain. To further aid in desirable spray characteristics this embodiment depicts an expansion of the deposition nozzle channel after the narrow point at a specific expansion angle 503. In this embodiment of the end effector, the narrow point would typically have a minimum/maximum diameter of 0.16 mm/1.22 mm respectively, the linear distance between the narrow point and most distal point of the deposition nozzle would typically not exceed 2 times the diameter of the narrow point, and the expansion angle would typically fall between 12 degrees and 39.5 degrees. These nozzle parameters are for UV curable fluids with viscosity between 20 cps and 890 cps at a temperature of 24.5 (+/−2.2) degrees Celsius.

The embodiment depicted in FIG. 6 includes a secondary material supplied through a channel in the deposition nozzle 604 into the primary curable material deposition stream 602 at an interface point 602. The two materials undergo co-mingling in the mixing chamber 601, before bead based or spray style deposition exiting from the distal tip of the deposition nozzle 401. This is designed for use when primary material volumetric flow rate is 7 or more times greater than a solid, powder based secondary material with diameter at most 15% the diameter of the distal tip of the deposition nozzle.

The distal end effector embodiment depicted in FIG. 7 shows a mechanism whereby a two part thermoset resin such as polyurethane, platinum or tin cure silicone, or epoxy may be mixed. In this case there would be two curable material supply lines 701 & 702 delivered to the distal end effector. They would make first contact with each other in the initial comingling chamber 703 before entering the beginning of a static mix tube 704 in which a plurality of baffles 705 cause the two materials to sufficiently mix before exiting the static mix portion 706 and being deposited via bead or spray from the distal tip of the deposition nozzle 401. The static mix portion of the deposition nozzle may have a heating element wrapped around it at the location shown by 707 for the purposes of speeding cure and or reducing viscosity for bead or spray deposition.

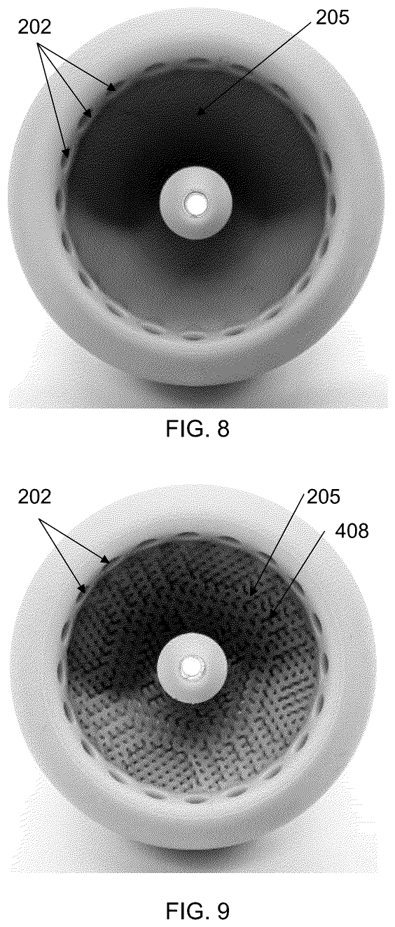

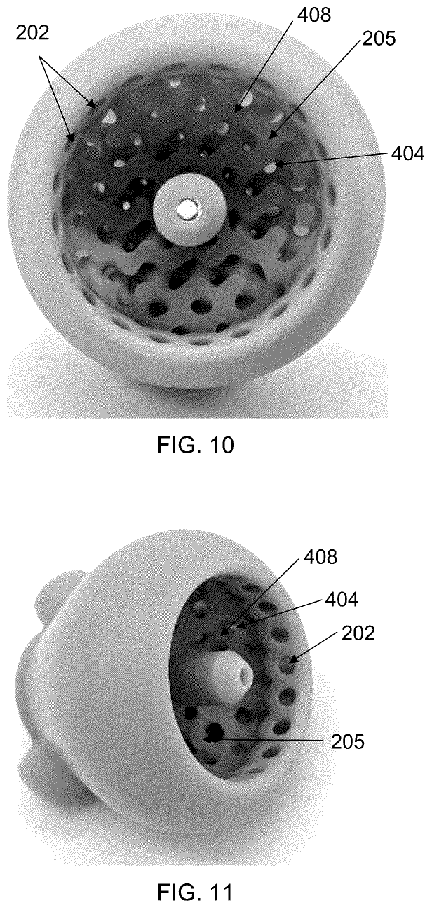

FIG. 8 is a picture of the embodiment previously described in FIG. 2, FIG. 3, and FIG. 4. In this embodiment it was fabricated via traditional SLA stereolithography in a material with relatively high strength and low brittleness. It is shown along with the FIG. 9, FIG. 10 and FIG. 11 to show how the mid body of the distal portion of the end effector can be expressed with different levels of porosity for the purpose of vacuum or forced air gas transfer. In FIG. 8, FIG. 9, FIG. 10 and FIG. 11 the surface of the mid body 205 is pointed out along with a plurality of the vacuum/forced air ports 202. In FIG. 9, FIG. 10 and FIG. 11 the volumetric portion of the midbody 408 is visible since the midbody in these cases are fabricated as a gas permeable network-specifically a gyroid lattice structure in these cases. Although the permeable mesh in FIG. 9 is too fine to see through, FIG. 10 and FIG. 11 both allow visibility all the way through to the internal vacuum/forced air channels 404.

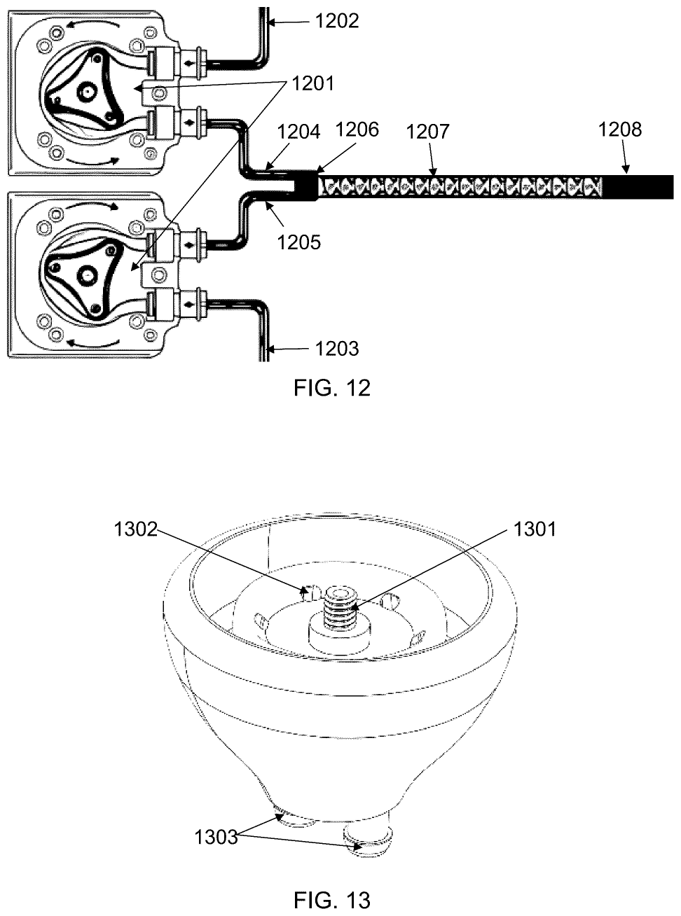

Positive displacement pumps, such as peristaltic pumps may be utilized to propel materials from the reservoirs to the deposition nozzle under controlled pressure. FIG. 12 shows a system of two peristaltic pumps 1201 that pull from two separate material reservoirs, material A via tube 1202, and material B via 1203. Material A and B are propelled through their respective pumps, to the pump outlets and through connecting materials lines 1204 and 1205 to a combination chamber 1206. Upon combination the two material are mixed via a static mix tube 1207 with a plurality of elements. Finally the material exits in a fully mixed state to the line 1208 that delivers the material to the distal end effector and deposition nozzle. This pumping and mixing mechanism may be located within the material reservoir system 111 as depicted in FIG. 2, in the distal end effector, or anywhere in between. The pumps and channels may be equipped with flow sensors and feedback controls to maintain a consistent material flow rate, which is essential for achieving uniform deposition layers and accurate geometries. The materials typically fall within the mix ratio of 1:1 to 2:1 however, some thermoset materials may have mix ratios up to or beyond 10:1.

For other applications requiring the combination of multiple materials for the purpose of catalyzing a polymerization reaction as in the case of thermoset polymers, or for adding a fiber, powder or other type of fill, the material delivery system may include mixers and/or mixing chambers such as the described static mix tubes integrated anywhere within or upstream of the deposition nozzle.

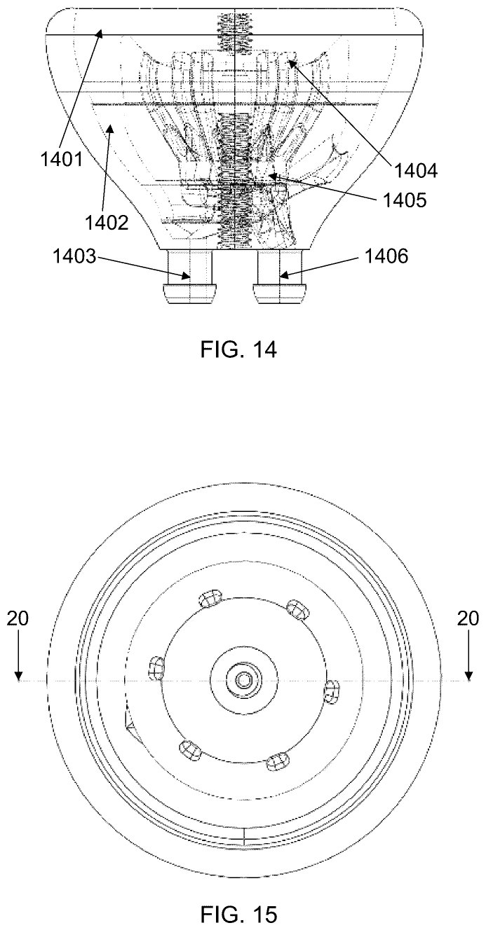

The embodiment of the distal portion of the end effector drawn in perspective view in FIG. 13 is significantly different from those described thus far in that this embodiment of the invention explicitly shows an interface for modular exchange of the deposition nozzle 1301. It shows a separate channel for vacuum or forced air 1302, and it shows a different orientation and fixturing mechanism for the vacuum/forced air lines shown as barbed nipple flexible tubing connectors 1303. FIG. 14 shows a drawing of the side view of this distal end effector embodiment with dotted lines for the internal geometries. There are two separate gas exchange manifolds, one of them is comprised of a circular opening 1401 funneling down into a roughly cylindrical channel 1402 that is finally converted into a single channel 1403 onto which transfer lines may connect. The other gas exchange manifold is comprised of a plurality of openings 1404 which converge into one roughly torus shaped chamber 1405 that is finally converted into a second channel 1406 onto which transfer lines may connect.

One of the advantages of a system like this is that depending on the application there may be two vacuum lines, two forced gas or fluid lines, or one vacuum and one forced gas line. For example, if the curing material is more sensitive to atmospheric conditions the plurality of openings 1404 could provide an inert gas directed at the workpiece, or similarly, they could alternate deposition between the primary curable material coming from the deposition nozzle and a protective fluid or secondary curable material to coat the workpiece. In either of theses cases, the larger opening to 1401 could be providing vacuum to remove any vapor, liquid or solid particulates. Alternatively, the larger 1401 opening could be forcing air into the area while the 1404 openings are providing vacuum inorder to create a contained environment that is continuously and predictably cycling atmosphere around the deposition nozzle and the workpiece.

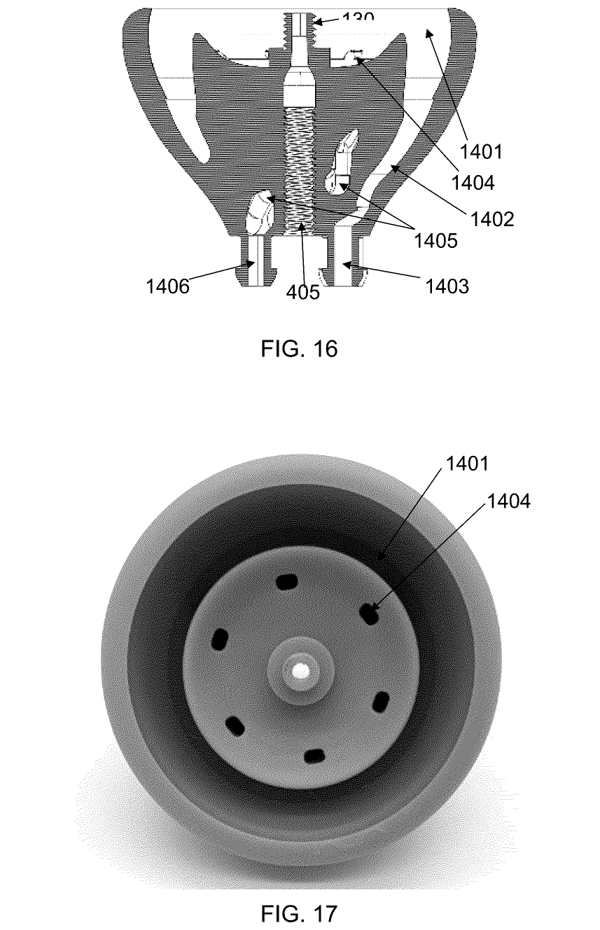

FIG. 15 shows the front view of the distal portion of the end effector in order to give reference for the cross sections plane 20 used in FIG. 16.

FIG. 16 is a the cross sectional view of the embodiment of the end effector depicted in FIG. 14 with a 180 degree rotation about the vertical axis. As in FIG. 14 the two separate gas exchange manifolds are shown. One gas exchange manifold is comprised of a circular opening 1401 funneling down into the funnel shaped channel 1402 that is finally converted into a single connection point for connection to another line 1403. The other gas exchange manifold is comprised of a plurality of openings 1404 which converge into the roughly torus shaped chamber 1405 before it is converted into a second channel 1406 onto which transfer lines may connect. In this embodiment there is the option for threaded attachments for fixturing to the robotic arm 405 or interchangeable nozzles 1301.

FIG. 17 is a frontal image of an traditional SLA additively manufactured distal end effector showing another vantage point on the circular gas/liquid exchange opening 1401 and the interconnected gas/liquid exchange openings connected to the other vacuum/supply line 1404.

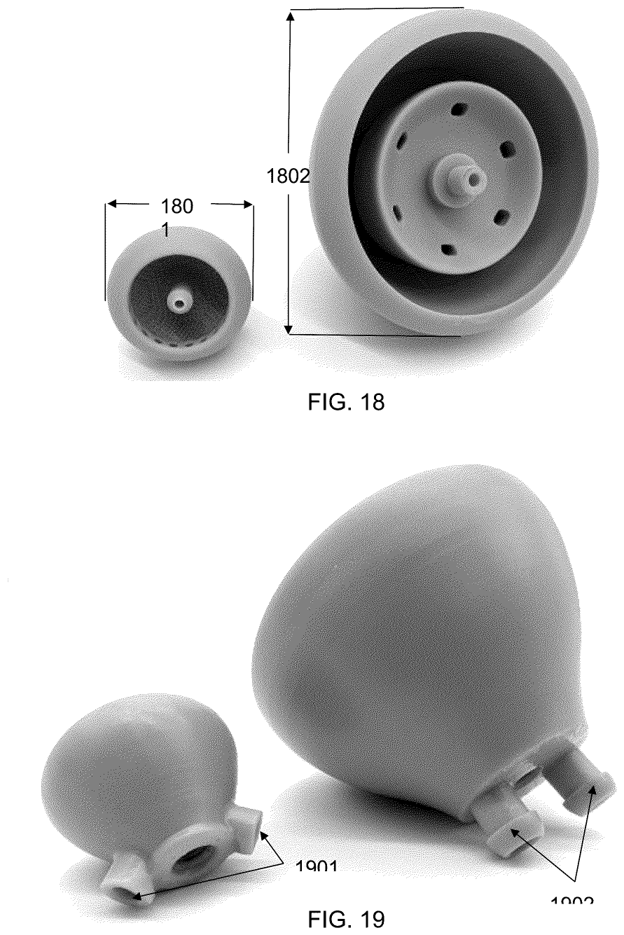

FIG. 18 shows a perspective view of two different embodiments of the distal portion of end effectors demonstrating the point that they be produced in different scales, as is shown by the significant proportional difference between the maximum diameters 1801 and 1802. FIG. 19 also emphasizes the that the vacuum/forced air connections may present with different orientations, connection mechanisms and sizes as shown by 1901 and 1902.

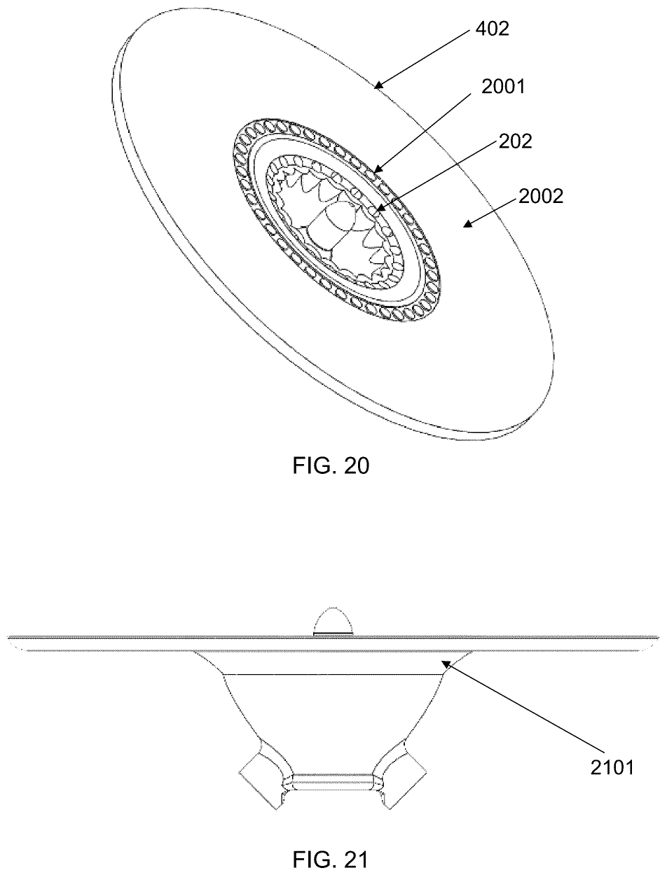

FIG. 20 is a perspective drawing showing that the distal lip of the end effector 402 can be larger than previously depicted in order to provide physical shielding of the workpiece from the environment and vica versa. For orientation, the vacuum/forced gas openings 202 are shown. Also in this embodiment, a ring of elements to aid in curing 2001 are shown, although these are shown in a ring they could be present anywhere on the distal portion of the end effector, particularly surfaces 2002 facing the direction of material deposition. These elements that aid in curing could provide UV light, heat or other energetic supply to enable proper cure. Also potentially embedded in this ring 2001, on the surface 2002 or on other areas of the distal end effector sensory components of the vision system may be embedded for workpiece measurement. FIG. 21 shows that there may be alternative structures and supports 2101 connecting the shield to the main body of the distal end effector.

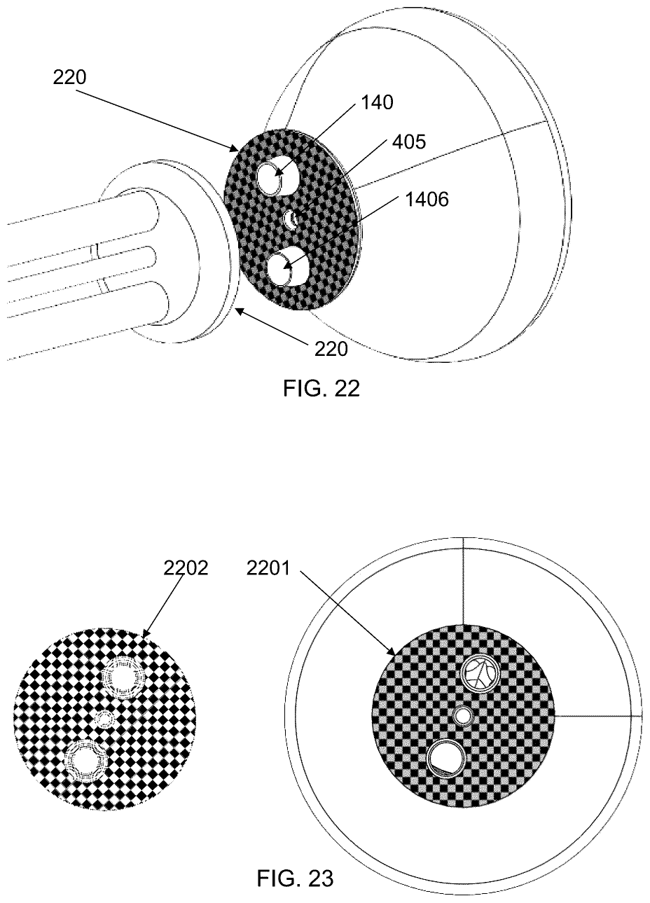

There are a plurality of expected methods for the distal portion of the end effector to be connected to the robotic mechanism and connected to the robot linkage portions of transfer lines for material, gas or liquid transfer, and/or connection points for electronics, fiber optics or other elements. FIG. 22 is a perspective drawing that shows one such alternative connection method. In this, surfaces 2201 and 2202 are enabled to be electrostatically or magnetically engaged with each other, providing a load bearing connection and sealing force for any connection points for vacuum/forced air ports 1403. 1406 and material ports 405. FIG. 23 provides straight on views of both sides of the connection where magnetic or electrostatically enabled surfaces may be present 2201, 2202. These surfaces do not need to be planar and may be adjusted for locating, orientation, and mechanical loading purposes.

A significant aspect of the invention is its ability to operate effectively in non-specialized environments. Unlike traditional additive manufacturing systems that require controlled environmental conditions—such as regulated temperature, humidity, and cleanliness—the present apparatus is designed with features that mitigate the need for such controls. Specialized protective shielding mechanisms as described earlier may be used in some embodiments of the invention to prevent contamination of the surroundings and/or protect sensitive components of the workpiece from environmental factors including but not limited to light, gasses, liquids, solids and other forces and fields. Robust material handling and material selection ensures that the materials and curing methods are less sensitive to temperature and humidity variations, allowing for operation on factory floors, outdoor settings, or other on-site locations.

In some embodiments, the end effector may incorporate a sophisticated vision system inclusive of various sensing technologies such as:
Visible Light Cameras: These capture images of the build area, providing detailed visual feedback of the manufacturing process.
Non-Visible Electromagnetic Sensors: Sensors operating in infrared or ultraviolet spectra detect thermal properties and monitor UV exposure levels during curing.
Three-Dimensional Scanning Devices: Utilizing technologies such as laser scanning, structured light, or photogrammetry, these devices create accurate three-dimensional models of the part in progress.
Field Sensors: These detect magnetic or electric fields, which is particularly useful when embedding magnetic or electronic components into the fabricated parts.

The vision system employs image processing algorithms to detect deviations from the intended build path or geometry. Algorithms may include edge detection, pattern recognition, and machine learning techniques that compare the actual build with the digital model. When deviations are detected, the system adjusts the robotic device's movements in real time to correct errors, ensuring high precision and part accuracy.

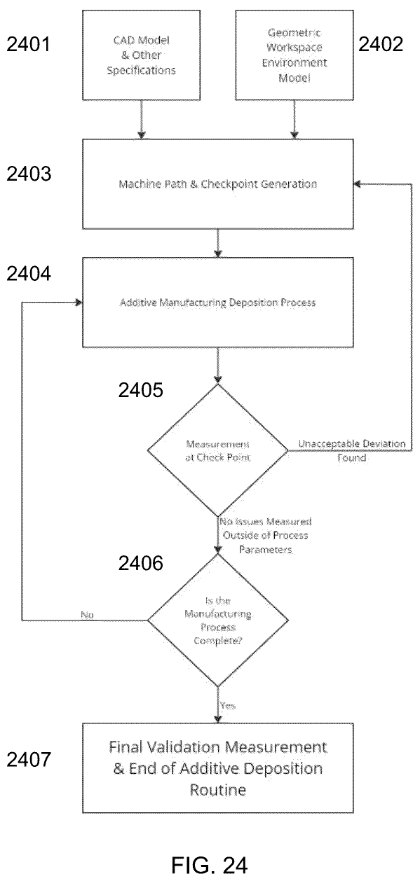

The real-time feedback provided by the vision system enables closed-loop control of the manufacturing process described later with reference to FIG. 24.

By continuously monitoring the deposition and curing processes, the system can adjust parameters such as:
Robotic Device Path: Fine-tuning movements to align precisely with the intended geometry of the part.
Material Flow Rate: Adjusting the deposition rate to maintain consistent material application, which is crucial for structural integrity and surface finish.
Curing Parameters: Modifying the intensity or duration of the curing energy based on material properties or environmental conditions to achieve optimal curing results.
Embedding Timing: Coordinating the placement of embedded objects to coincide with the material's optimal state for adhesion, ensuring proper integration of components.

FIG. 24 Goes through the core steps in the process of vision system enabled additive manufacturing with this platform. The initial inputs are the CAD model and other process specifications 2401 and a geometric model of the workspace 2402, particularly the substrate that the process will be utilizing, and any fixed or dynamic environmental factors that may interfere with the manufacturing process. These factors feed into a machine path generation software 2403 likely onboard the computation system 114. This machine pathing, called slicing in traditional additive manufacturing, may also designate set or continuous checkpoints during which the vision system of the end effector measures the workpiece and determines if it is in or out of tolerance. Once the machine pathing is complete the additive manufacturing deposition process 2404 may commence. Continuously and/or at set precalculated checkpoints through the AM deposition process measurements 2405 by the vision system are performed. If an unacceptable deviation is found the system returns to 2403 to regenerate the machine paths and checkpoints, and if there are no issues it proceeds. Upon completion of the manufacturing process 2406 after all checkpoints 2405 have been passed, the system performs and stores the final validation measurement 2407. During this final measurement of the finished part, it may perform end routines such as clearing the nozzle for future use.

One of the significant advantages of the present invention is its ability to operate in non-specialized environments without compromising performance. The system is designed with features that eliminate the need for controlled environmental conditions with embodiments including appropriate mechanisms for protective shielding, filtration and material handling. These mechanisms prevent contamination of the surroundings by containing curing energy (e.g., UV light) and capturing any byproducts or unattached materials. This ensures safety and maintains the integrity of both the manufactured part and the operating environment. The selection of materials and curing methods that are less sensitive to temperature and humidity variations allows the system to function effectively in variable conditions. This adaptability expands the applicability of additive manufacturing to settings such as on-site repairs, construction sites, or areas lacking climate control.

### Integrated Curing Unit

In many embodiments the integrated curing unit is positioned adjacent to the deposition nozzle, enabling abbreviated or immediate curing of the deposited material. This proximity ensures that the material solidifies promptly, maintaining the structural integrity of the part and allowing for complex geometries without support structures. There are a number of curing mechanisms
UV Light Source: For materials that cure via photopolymerization, the curing unit includes a UV light source emitting specific wavelengths suitable for initiating the curing reaction in the deposited material such as 405 nm light. The light source can be generated via a local array of LEDs or a laser diode, providing focused and efficient energy delivery, or it could be generated in a more proximal portion of the end effector apparatus and transported via fiber optic.
Physical Catalyst Introducer: For thermosetting materials requiring a catalyst, the curing unit incorporates a catalyst introduction system. This system introduces a physical catalyst into the material stream within a mixing chamber or directly onto the deposited material. Methods of introduction and mixing may include static mix tubes, micro-dispensing, aerosolization, or encapsulated catalyst particles that release upon deposition. Since some of these materials may have a longer cure time, they may be introduced early on in the end effector such as an external stationary component from the robotic mechanism as drawn in FIG. 12, or a the last moment before material is deposited as drawn in FIG. 7.
Heating Elements: For materials that cure through the application of heat, the curing unit may contain localized heating elements that apply controlled thermal energy to the deposited material. This heat can be imparted in many ways including as material travels through the nozzle, be transmitted as light, or as radiant heating directed towards the workpiece.

The curing unit is synchronized with the deposition nozzle's movements and material flow, ensuring that curing occurs precisely where and when needed.

### Protective Shielding Mechanism

In many embodiments of the distal portion of the end effector, a protective shielding mechanism may surround the curing unit in order to prevent unintended exposure of curing energy to the surrounding environment and to enhance safety. The shielding may be designed as an actuated or fixed shroud made from materials opaque to the curing energy wavelengths, such as UV-blocking polymers, metals, and/or ceramics. It serves to contain the curing energy within the immediate deposition area, preventing exposure to operators and sensitive equipment, complying with safety regulations. The shielding may also serve to minimize the influence of ambient light or contaminants on the material during the curing process, enhancing the reliability of material solidification.

Another form of protective shield is in the form of gas and airborne particulate transfer. This can be introduced to the atmospheric envelope of curing material for many purposes including as a shielding gas to prevent contamination of uncured material. This type of shielding gas could be specialized to the material, or air that may be filtered or heated. Some embodiments of the end effector may vacuum gas away from the site of deposition. In this case, the purpose is likely to protect the surrounding area from un adhered solid particulates, or to remove and contain fluids or gasses to prevent them from entering the local environment.

Furthermore filtration media may be integrated into the end effector to capture and contain unattached materials, byproducts, or particulates generated during deposition and curing. The filtration system may include absorptive materials, such as activated carbon filters or specialized polymers, that passively capture fumes, vapors, or excess material. Alternatively, active filtration may be used in embodiments with a vacuum system that draws air and particulates through filters. The suction force can be adjusted based on the material and process requirements, ensuring effective containment without disturbing the deposition process.

In the cases in which filtration media is used, they may be integrated with removal and replacement in mind, or be integrated directly into the end effector. Collected materials are contained within the filtration system, allowing for safe disposal or recycling in accordance with environmental regulations, though in some cases, filtration is all that is needed before release back into the local atmosphere.

### Attachment Mechanism to Robotic Device

The end effector is designed to be attachable to various robotic devices through a versatile attachment mechanism, ensuring compatibility and ease of use. There are several expected methods for attachment of the part of the end effector that directly deposits material through the nozzle to a robotic carrier. These include Magnetic Coupling, Electrostatic adhesion, mechanical clamping or any combination of two or more methods. Embodiments utilizing permanent magnets or electromagnets may be used for locating or orienting surfaces, connections or provide quick and secure attachment. Magnetic coupling may allow for rapid end effector changes without the need for mechanical fasteners. In some embodiments electrostatic forces may be used to adhere the end effector to the robotic device, enabling a smooth surface interface and reducing mechanical complexity. Traditional mechanical interfaces, may also be used, such as bayonet mounts, quick-release clamps, or threaded connections, or even a clamping claw mechanism more traditional to robotic arms.

To accommodate slight misalignments and reduce mechanical stress, the attachment mechanism may include universal joints or flexible couplings. These components may allow for angular adjustments and absorb vibrations during operation, enhancing precision and extending the lifespan of the equipment.

### Sensors and Feedback Systems

Some embodiments of the end effector incorporate one or more sensors and feedback systems in addition to those based on visible light in order to monitor and optimize the additive manufacturing process in real time. These sensors may include those for temperature, force feedback, and geometries.
Temperature Sensors may include embedded thermocouples or infrared sensors to monitor the temperature of the deposited material and the curing unit.
Load cells or piezoelectric sensors embedded in the deposition nozzle or other component of the end effector may be used to detect the force exerted by the end effector during material deposition, or to probe the substrate or workpiece in order to test it's materials properties such as hardness or elastic modulus. There may also be used environmental sensors for measuring ambient temperature, humidity, light exposure, and atmospheric composition (e.g., oxygen levels) help adjust process parameters to account for environmental variations.

### Data Processing and Control Systems

Data Collection: Sensor data is collected by an onboard processor or transmitted to an external control system.

Machine Learning Algorithms: Advanced algorithms analyze the sensor data to identify patterns, predict potential issues, and recommend adjustments. Machine learning enables the system to improve over time, enhancing process efficiency and part quality.

Predictive Adjustments: The control system utilizes predictive models to adjust deposition speed, curing intensity, and other parameters before deviations occur, maintaining optimal conditions throughout the manufacturing process.

Feedback Loop Mechanisms may include real-time adjustments to the machine path and speed, shielding and deposition parameters. Immediate feedback from sensors allows the system to adjust material flow rates, curing energy output, and robotic movements in real time. For example, if temperature sensors detect a drop in material temperature, the heating mechanism can increase output to maintain viscosity. Continuous monitoring and adjustments ensure consistent layer deposition, proper curing, and adherence to the intended geometry, resulting in higher-quality parts with reduced defects.

Some embodiments of the end effector may include an inert gas delivery system that supplies gasses such as nitrogen or argon around the deposition area. This system prevents oxidation and contamination of sensitive materials during deposition and curing. Alternatively air may be used as is, for thermal management of the local atmosphere in order to heat or cool the workpiece, or even in some cases exert supportive or deformatory forces upon it. Gas is delivered through nozzles or diffusers strategically positioned around the deposition point. Flow rates and coverage are controlled to ensure effective shielding without disrupting the material deposition.

Material Preheating may be used in some embodiments of the end effector in order to improve deposition and curing properties. The heating mechanism may surround the deposition nozzle in order to preheat deposition materials for the purposes of reducing viscosity and improving flow characteristics, or to have a desired impact on curing characteristics. This can be particularly beneficial for thermosetting materials that require specific temperature ranges for optimal deposition. The heating element may operate in conjunction with temperature sensors to maintain precise control over material temperatures. Adjustable heating profiles can be programmed based on material properties and desired deposition rates and also work in conjunction with the sensor and feedback system.

### Material Deposition Process

The material deposition process is a critical aspect of the end effector apparatus, enabling precise and controlled fabrication of three-dimensional structures. The process encompasses material handling and preparation, various deposition methods, and the capability for multi-material deposition to create composite structures.

Different embodiments of the end effector apparatus may support multiple deposition methods to accommodate different manufacturing requirements and material properties. The primary methods include bead deposition and spray deposition, each suited to specific applications and desired outcomes.

For embodiments of the end effector in which bead deposition materials are applicable, the material is extruded from the deposition nozzle as a continuous or intermittent bead onto the substrate or previously deposited layers. The nozzle orifice size and shape may be adjusted using a variable aperture mechanism when relevant to control the width and thickness of the bead. The robotic device moves the end effector along predetermined paths, laying down material in precise locations according to the digital model.

Bead deposition can be ideal for creating structural components where material strength and integrity are paramount. Bead deposition method accommodates materials with higher viscosities that may not be suitable for spraying, it is also the method whereby material can be most rapidly deposited from a volumetric standpoint in many circumstances especially when feature detail and surface finish are not critical. Bead deposition allows for the building of parts in dots, beads and/or the culminating planar or non-planar layers, and provides control over the internal structure and density.

For embodiments of the invention in which spray deposition of material is applicable, spray deposition typically involves atomizing the material as it exits the deposition nozzle, creating a fine mist or spray that is directed onto the target surface. This is achieved by introducing compressed air or inert gas into the nozzle or by utilizing sufficiently tuned pumps and valves to force the material through the deposition nozzle at velocity.

Spray deposition tends to require materials with lower viscosities to facilitate atomization. The material may be diluted or heated to reduce viscosity. The temperature control units and heating mechanisms may play a crucial role in adjusting material viscosity. Specialized nozzle designs with internal geometries optimized for spray formation are used to ensure consistent droplet size and spray patterns.

Spray deposition is well-suited for applying uniform coatings over large or irregular surfaces. It enables the creation of fine features and smooth surfaces due to the thin layers achievable through spraying. When combined with selective deposition techniques, spray deposition can be used to create complex composite structures with varying material properties, and can be used in conjunction with other end effectors utilizing bead style deposition.

Some embodiments of the end effector may be designed to handle multiple materials either simultaneously or sequentially, expanding the capabilities of this additive manufacturing system to include composite and multi-material structures.

Some embodiments of the end effector may be equipped to switch between different materials during the manufacturing process. This can be achieved by purging the current material from the nozzle when necessary and introducing the next material, facilitated by the control system coordinating the present pumps and valves. Sequential deposition may be used to enable the construction of layered composites, where distinct materials are deposited in separate layers or regions within the part. Embedding materials with specific functions (e.g., conductive inks for circuitry, elastomers for flexible joints) may be used to enhance the functionality of the manufactured part. Integrating multiple materials during fabrication can reduce or eliminate the need for post-processing assembly, saving time and cost. Furthermore, the ability to create composite structures opens up possibilities for advanced applications, such as embedded sensors, actuators, or tailored structural performance.

### Integration With the Robotic Device

The robotic device's multi-axis capabilities enable the end effector to deposit materials along complex paths and orientations, essential for both bead and spray deposition methods. The synchronization between the material deposition process and the robotic movements ensures accurate material placement and optimal build quality. Real time adjustments to the robotic machine path can utilize data from the end effector's vision system and sensors.

### Operation in Non-specialized Environments

The present invention provides an end effector apparatus engineered to function effectively in non-specialized environments, wherein controlled conditions such as regulated temperature, humidity, and air purity are absent. This adaptability significantly broadens the applicability of the additive manufacturing system, enabling its utilization in diverse settings including factory floors, outdoor sites, and on-site repair locations.

The apparatus may be constructed from materials exhibiting resistance to environmental fluctuations. Components such as the deposition nozzle, integrated curing unit, and sensor assemblies may be fabricated from materials with low thermal expansion coefficients and high resistance to corrosion and moisture ingress, such as stainless steel alloys, high-performance polymers, or ceramic composites. The curable materials employed may be specifically formulated to exhibit reduced sensitivity to temperature and humidity variations. UV-curable resins with broad operating temperature ranges and thermosetting materials with stable curing kinetics under variable conditions may be selected to maintain consistent performance.

Critical components of the design are housed within protective enclosures designed to shield them from dust, moisture, and temperature extremes. Seals and gaskets fabricated from elastomeric materials prevent the ingress of contaminants. The apparatus incorporates thermal management systems where necessary, with some embodiments including passive heat sinks, active cooling fans and dissipative heaters, to maintain optimal operating temperatures for electronic components and sensors, thereby ensuring consistent functionality.

### Examples of Non-specialized Settings

Factory Floors: In industrial manufacturing facilities, environmental conditions may vary due to factors such as open bay doors, proximity to heavy machinery, or fluctuating HVAC performance. The real-time adjustments to deposition parameters in some embodiments of the end effector, based on sensor feedback, enable the system to maintain consistent performance despite temperature changes resulting from environmental interference such as drafts or adjacent machinery operation.

Outdoor environments present challenges such as temperature extremes, humidity variations, wind exposure, and precipitation. Embodiments of the apparatus may be equipped with weather-resistant housings and seals to protect internal components from environmental elements. Optional deployment of portable enclosures or shields may be used to provide temporary protection from direct sunlight or precipitation during operation. Enhanced environmental sensors detect rapid environmental changes, prompting the control system to adjust operational parameters or initiate safe shutdown procedures if necessary.

On-Site Repairs: Field repairs of large equipment, infrastructure, or structures may require the additive manufacturing system to operate in situ, often in remote or inaccessible locations. The end effector in these embodiments may be designed for mobility, being lightweight and compatible with portable robotic devices, facilitating transportation and rapid deployment. The apparatus in such an embodiment may be out fitted to be capable of operating using portable power sources, such as batteries or generators, accommodating locations without access to electrical grids.

Calibration Procedures: Prior to operation in a new environment, the system may perform calibration routines to establish baseline sensor readings and adjust control parameters accordingly. The control system may periodically recalibrate during operation based on sensor data to adapt to gradual environmental changes, ensuring sustained performance.

### Best Mode Contemplated

The preferred embodiment of the present invention involves an end effector apparatus integrated with a six-axis robotic arm, providing the necessary degrees of freedom and load capacity for complex additive manufacturing tasks. The selection of a six-axis robotic arm is based on its versatility and ability to position the end effector in virtually any orientation, enabling the fabrication of intricate geometries and non-planar machine paths.

The end effector is designed to deposit a UV-curable resin, chosen for its rapid curing properties to a rigid, tough solid and ability to produce high-resolution features.

An integrated UV light source serves as the curing unit, emitting wavelengths specifically matched to the photoinitiators in the resin. The UV light source is positioned adjacent to the deposition nozzle to enable in situ curing within 0.5 seconds of material deposition. This proximity ensures that the deposited material maintains its intended shape and adheres properly to previous layers, enhancing the structural integrity of the fabricated part.

The vision system is a critical component of the preferred embodiment, employing high-resolution cameras mounted on the end effector. These cameras capture detailed images of the deposition process, providing real-time data on the geometry and condition of the deposited material. The vision system may also include sensors operating in non-visible spectra, such as infrared sensors to monitor thermal properties, ensuring that the material remains within optimal temperature ranges during curing.

Machine learning algorithms may be utilized to process the sensor data, enabling the system to optimize operational parameters dynamically. The algorithms analyze patterns and deviations in the deposition process, adjusting variables such as the robotic arm's movement paths, material flow rates, and curing energy intensity. This adaptive control enhances precision, compensates for environmental variations, and reduces the likelihood of defects or inconsistencies in the final product.

The control algorithms are programmed to handle specific tasks and adjustments required for the chosen materials and manufacturing objectives. For example, they manage the synchronization between material deposition and curing, coordinate the deposition of multiple materials when creating composite structures, and adjust the end effector's movements to accommodate complex geometries.

Operating on a factory floor without additional environmental controls exemplifies the apparatus's ability to function in non-specialized environments. The design choices, such as the selection of durable materials for the end effector components and the incorporation of protective shielding, will enable the system to perform reliably amidst typical industrial conditions.

The absence of human supervision during operation is facilitated by the system's autonomous capabilities. The integration of advanced sensors, real-time data processing, and adaptive control algorithms allows the apparatus to perform additive manufacturing tasks with minimal human intervention. Safety features, such as emergency shutdown protocols and protective shielding, ensure safe operation even in the event of unforeseen circumstances.

Certain design choices were made to optimize performance in the preferred embodiment:
Material Selection: The use of UV-curable resin provides rapid curing and high-resolution output, essential for applications requiring precise feature definition. The resin's compatibility with the integrated UV curing unit simplifies the system design and enhances efficiency.
Design Features: The incorporation of a variable aperture mechanism in the deposition nozzle allows for adjustable material flow, accommodating different feature sizes and layer thicknesses. Ultrasonic vibration capabilities reduce material viscosity during deposition, improving flow characteristics and surface finish.
Sensor Integration: High-resolution cameras and environmental sensors enable comprehensive monitoring of the manufacturing process. The data collected supports the adaptive control system, ensuring optimal deposition conditions and rapid response to any deviations.
Control System Architecture: The use of machine learning algorithms in the control system allows for continuous improvement in operational efficiency and part quality. The system learns from each manufacturing cycle, refining its adjustments and predictions over time.
Robotic Device Selection: A six-axis robotic arm provides the necessary flexibility and precision for complex additive manufacturing tasks. Its compatibility with the end effector apparatus ensures seamless integration and coordinated operation.

By implementing these choices, the preferred embodiment achieves a balance between performance, adaptability, and efficiency. The system would be capable of producing high-quality parts with intricate geometries while operating in environments lacking specialized controls. This embodiment represents the best mode contemplated for practicing the invention, providing a practical and effective solution for advanced additive manufacturing applications across various industries.

While the invention herein disclosed has been described by means of specific embodiments, examples and applications thereof, numerous modifications and variations could be made thereto by those skilled in the art without departing from the scope of the invention set forth in the claims.

1. An additive manufacturing end effector apparatus, comprising:
a deposition nozzle configured to deposit UV or thermoset curing materials;
an integrated curing unit configured to cure the deposited material in situ;
wherein the apparatus is configured to be attachable to a robotic device.

2. The end effector of claim 1, wherein the integrated curing unit is a UV light source emitting wavelengths suitable for curing the deposited material.

3. The end effector of claim 1, wherein the integrated curing unit introduces a physical catalyst to the material to initiate curing.

4. The end effector of claim 1, wherein the deposition nozzle can combine multiple materials prior to deposition.

5. The end effector of claim 1, further comprising a protective shielding mechanism surrounding the curing unit to prevent exposure of curing energy to unintended areas.

6. The end effector of claim 1, further comprising a vacuum system that suctions gas and particulates from the deposition area.

7. The end effector of claim 6, further comprising a filtration media that filters or encapsulates unattached material or byproducts of deposition or curing.

8. The end effector of claim 1, further comprising an inert gas delivery system that creates a localized, controlled atmosphere around the deposition area.

9. The end effector of claim 1, further comprising a heating mechanism adjacent to the deposition nozzle to preheat the material before deposition.

10. The end effector of claim 1, further comprising a vision system with sensors configured to monitor the temperature, geometry, and other physical properties of the deposited material during deposition, curing, and build up.

11. The end effector of claim 10, wherein the integrated curing unit adjusts deposition and/or curing parameters in response to data from the sensors to optimize the produced geometry, material properties or curing process.

12. The end effector of claim 1, wherein the deposition nozzle is equipped with a variable aperture mechanism that adjusts the size or shape of the nozzle.

13. The end effector of claim 1, further comprising force feedback sensors configured to monitor hardness, and stiffness of the deposited material.

14. The end effector of claim 1, wherein the deposition nozzle is capable of rotating independently of the robotic device's movements, providing additional degrees of freedom for complex material deposition paths.

15. The end effector of claim 1, wherein the deposition nozzle is configured to deposit multiple materials simultaneously or sequentially, allowing for composite or multi-material structures.

16. The end effector of claim 1, capable of either depositing as a bead or spraying the curable material onto the in situ location.

17. A method for additive manufacturing using an end effector apparatus as in claim 1, the method comprising:
attaching the end effector apparatus to a robotic device;
depositing a UV-curable or thermosetting material onto a substrate using a deposition nozzle;
curing the deposited material in situ with an integrated curing unit;
wherein the deposition nozzle deposits the material either as a bead or by spraying onto the substrate or workpiece.

18. The method of claim 17, further comprising a vision system with sensors to monitor the temperature, geometry, hardness, stiffness, and/or other physical properties of the deposited material during deposition, curing, and buildup.

19. The method of claim 18, wherein the robotic device's movement paths are actively adapted based on sensor data to correct deviations from the intended build geometry, ensuring accurate material placement and part fidelity.

20. The method of claim 19, wherein the robotic device has 6 or more degrees of freedom.
